(19) United States
(12) Patent Application Publication
(10) Pub. No.: US 2014/0254003 A1
(43) Pub. Date: Sep. 11, 2014

(54) REFLECTIVE OPTICAL SYSTEM AND ASTRONOMICAL OBSERVATION DEVICE USING THE SAME

(71) Applicant: CANON KABUSHIKI KAISHA, TOKYO (JP)

(72) Inventors: Yuji Katashiba, Kawasaki-shi (JP); Toru Matsuda, Utsunomiya-shi (JP)

(21) Appl. No.: 14/197,074

(22) Filed: Mar. 4, 2014

(30) Foreign Application Priority Data
Mar. 6, 2013 (JP) 2013-044289

(51) Int. Cl. G02B 23/06

(52) U.S. Cl. CPC G02B 23/06
USPC 359/366

(57) ABSTRACT

A reflective optical system includes: a telescope section which includes a concave primary mirror and a concave secondary mirror; and a collimator section which includes at least one concave mirror disposed in a tilted manner with respect to an optical axis of the telescope section and at least one convex mirror disposed in a tilted manner with respect to the optical axis of the telescope section and on which converged light flux is incident, the collimator section receiving light flux from the telescope section.

### BACKGROUND

1. Field of Art

The present disclosure relates to a high-resolution reflective optical system mounted on an artificial satellite or the like for observing astronomical objects in a wide wavelength range, and relates to an astronomical observation device using the reflective optical system.

2. Description of the Related Art

Regarding a telescope used for astronomical observation, the larger the aperture, the higher the resolution and the stronger the light condensing power. Therefore, a large-aperture telescope is needed to obtain high observation performance. However, if the aperture size exceeds about 1 m, it becomes difficult to manufacture a high quality lens as a lens material. Therefore, in the field of a large-aperture telescope, a reflecting telescope using only mirrors is mainly used. In spectroscopic observation of astronomical objects, observation of light in a wide wavelength range from ultraviolet to infrared is needed. Since a glass material of the lens significantly reduces transmittance of the ultraviolet, the reflecting telescope is needed also from this reason.

Observation equipment mounted on an artificial satellite to be launched with a rocket or the like from the earth is desirably small in size and weight because if the observation equipment is large in size and weight, cost for development and operation thereof becomes significantly large. Since the Cassegrain (including the Ritchey-Chretien) reflecting telescope having a telescope section in which light flux is reflected on a concave primary mirror and a convex secondary mirror achieves short total length while realizing high magnification, i.e., long focal length, the Cassegrain reflecting telescope is widely used also as an optical system mounted on an artificial satellite.

Since the Gregorian reflecting telescope having a telescope section in which an image is formed on the focus of a concave primary mirror and a concave secondary mirror is disposed behind the concave primary mirror where the image is formed, a diaphragm and an exhaust heat mirror are disposed at an intermediate image position to discharge undesirable light and rays of thermal infrared wavelength, the Gregorian reflecting telescope is often used to observe the sun.

Generally, the Cassegrain reflecting telescope and the Gregorian reflecting telescope have an advantage that no chromatic aberration is caused while they have a disadvantage that a curvature of field is caused and, further, large off-axis aberration, such as coma aberration and astigmatism, is caused when a viewing angle is increased.

In a reflective optical system disclosed as a Cassegrain telescope system in U.S. Pat. No. 4,101,195, a combination of three mirrors has eliminated the curvature of field and achieved favorable imaging performance across a wide viewing angle. Here, a reflective optical system that is based on the reflective optical system disclosed in U.S. Pat. No. 4,101,195 and that is designed on the condition of the effective diameter of φ400 mm and the focal length of 4800 mm is illustrated in FIG. 10 as Comparative Example 1 (an entire three-mirror reflective optical system including the Cassegrain telescope section).

In the reflective optical system illustrated in FIG. 10, since a secondary mirror M20 is a strongly convex mirror, the curvature of field is eliminated by substantially cancelling the Petzval sum of other two less strongly concave mirrors M10 and M30, and the reflective optical system achieves high subject resolution of a diffraction limit in a visual field range of 1.5-degree angle.

If spectroscopic observation or the like is performed in addition to capturing images of astronomical objects, since a subsequent observation device such as a spectroscope is disposed behind the focal plane of the reflecting telescope, a collimator section is needed between the telescope section and the observation device. If observation is performed in a wide wavelength range, this collimator section is also need to be configured only by mirrors. The simplest configuration of the reflective collimator in which the telescope section is the Gregorian reflective optical system and the collimator section is constituted only by mirrors may be a configuration in which a single concave parabolic mirror M31 is used for a concave primary mirror M11 and a concave secondary mirror M21 as illustrated in FIG. 11 as Comparative Example 2.

Taking an advantage of the characteristic that two parabolic mirrors which share a focus cancel out coma aberration and astigmatism, it is possible to desirably correct aberration other than the curvature of field by properly selecting the focal length of the parabolic mirror on the side of the collimator section. However, in the reflective optical system in which the telescope section is the Gregorian telescope, since the Petzval sum is not able to be cancelled and the curvature of field remains: thus, it is necessary to correct the curvature of field.

### SUMMARY

A reflective optical system including: a telescope section which includes a concave primary mirror and a concave secondary mirror; and a collimator section which includes at least one concave mirror disposed in a tilted manner with respect to an optical axis of the telescope section and at least one convex mirror disposed in a tilted manner with respect to the optical axis of the telescope section and on which converged light flux is incident, the collimator section receiving light flux from the telescope section.

### Operation

In order to reduce the size of the reflective optical system, each mirror of the mirror group of the collimator section including the concave surface is disposed in a tilted manner with respect to the optical axis of the telescope section and the convex mirror is provided as a mirror in the collimator section so as to correct the curvature of field, and the position of this convex mirror is defined as a converged incident light flux position so as to achieve the reduction in size.

Further features of the present disclosure will become apparent from the following description of exemplary embodiments with reference to the attached drawings.

### BRIEF DESCRIPTION OF THE DRAWINGS

FIG. 1 is a diagram illustrating an optical arrangement of a reflective optical system according to a first embodiment of the present disclosure.

FIG. 2 is an enlarged view of a collimator section of the reflective optical system according to the first embodiment.

FIG. 3 is a diagram illustrating wavefront aberration of the reflective optical system according to the first embodiment.

FIG. 4 is a spot diagram illustrating the reflective optical system according to the first embodiment.

FIG. 5 is a diagram illustrating an optical arrangement of a reflective optical system according to a second embodiment of the present disclosure.

FIG. 6 is an enlarged view of a collimator section of the reflective optical system according to the second embodiment.

FIG. 7 is a diagram illustrating wavefront aberration of the reflective optical system according to the second embodiment.

FIG. 8 is a spot diagram illustrating the reflective optical system according to the second embodiment.

FIG. 9 is an enlarged view of a collimator section of a reflective optical system according to a third embodiment.

FIG. 10 is a diagram illustrating an optical arrangement of Comparative Example 1 (an entire three-mirror reflective optical system including a Cassegrain telescope section).

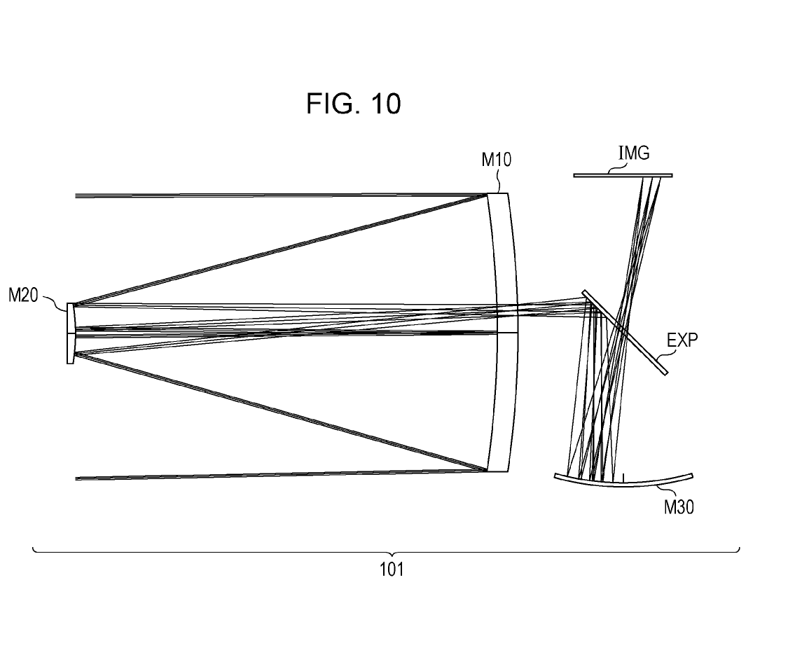

FIG. 11 is a diagram illustrating an optical arrangement of Comparative Example 2 (a reflective optical system including a Gregorian telescope section).

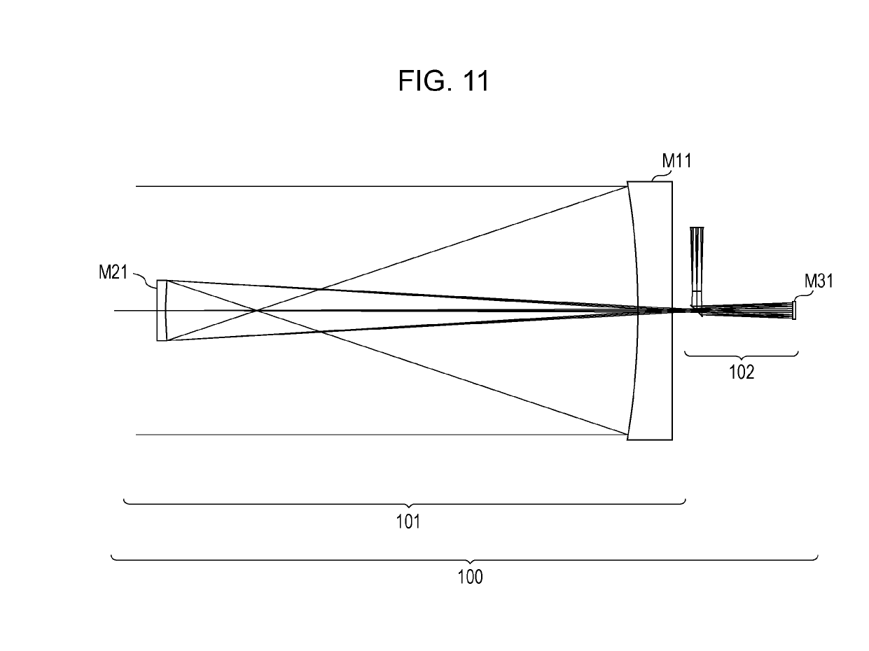

### DESCRIPTION OF THE EMBODIMENTS

The present disclosure provides a reflective optical system of the Gregorian telescope, which is capable of maintaining reduction in size of an optical system and correcting curvature of field, and the present disclosure provides an astronomical observation device using the reflective optical system. Hereinafter, embodiments of the present disclosure will be described with reference to the drawings.

### First Embodiment

### Astronomical Observation Device

An astronomical observation device mounted on an artificial satellite and placed in an orbit around the earth, an orbit around an astronomical object or the like includes a reflective optical system described below and a subsequent observation device thereof.

### Reflective Optical System

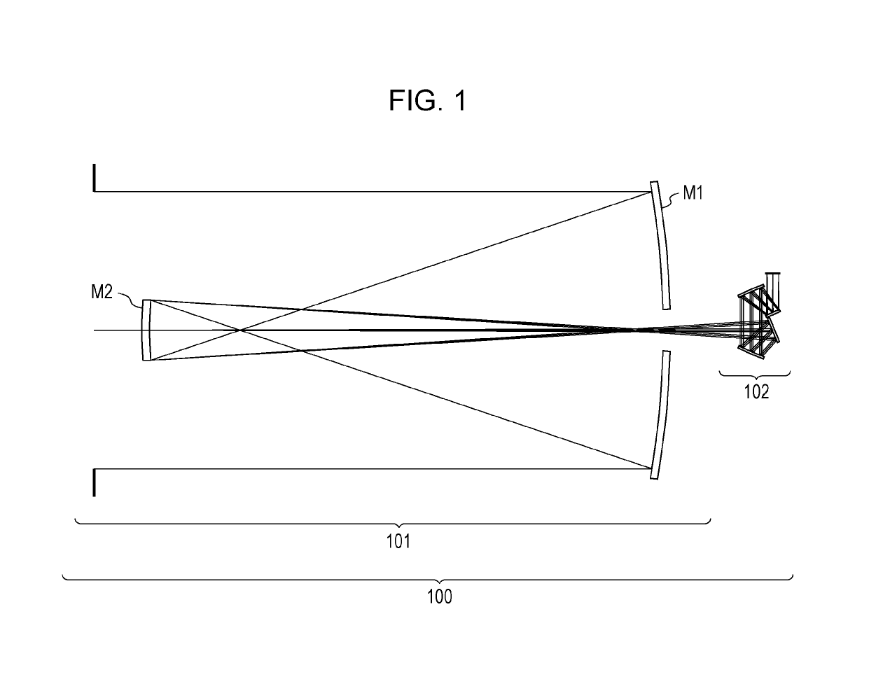

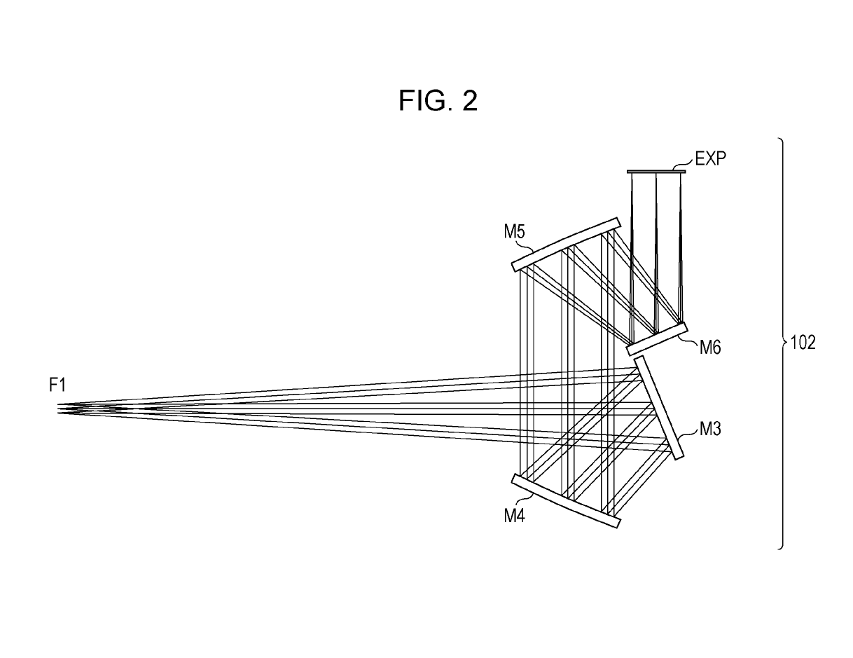

FIG. 1 is a diagram illustrating an optical arrangement of a reflective optical system according to a first embodiment of the present disclosure. In FIG. 1, the reference numeral 100 denotes the reflective optical system, 101 denotes a telescope section and 102 denotes a reflective collimator section which receives light flux emitted from the telescope section. M1 is a primary mirror of the telescope section and M2 is a secondary mirror of the telescope section. FIG. 2 is an enlarged view of the collimator section. In FIG. 2, a first mirror M3, a second mirror M4, a third mirror M5 and a fourth mirror M6 arranged in this order along an optical path are four mirrors as a mirror group which constitutes the collimator section. Here, M6 is disposed at the rearmost position along the optical path from a subject image position (a focal plane F1 position) and reflects converged light flux as collimated light flux.

The reflective optical system 100 is mounted on an unillustrated artificial satellite and is placed in an orbit around the earth, an orbit around an astronomical object or the like. Observation light incident from the earth surface or an astronomical object which is a subject is reflected on the concave primary mirror M1 having a hole at the center thereof, reflected on the concave secondary mirror M2, and then an image of the subject is formed on the focal plane F1 (the subject image position) of the telescope section. The observation light is then reflected on the four mirrors (M3, M4, M5 and M6 in this order along the optical path) arranged in a respectively tilted manner with respect to the optical axis of the telescope section 101 in order to reduce the size of the reflective optical system and forms an exit pupil at a position of EXP. The collimated light flux emitted from the collimator section 102 is led to a subsequent observation device (not illustrated).

The primary mirror M1 of the telescope section is shaped as a concave, hyperboloid of revolution, like a paraboloid of revolution and the secondary mirror M2 of the telescope section is shaped as a concave, ellipsoid of revolution. The mirrors M1 and M2 constitute the telescope section (a reflecting telescope) of the Gregorian telescope. The image of the subject is once formed on the focal plane F1 of the telescope section, but aberration is not necessarily corrected desirably only by the telescope section. The first mirror M3, the second mirror M4, the third mirror M5 and the fourth mirror M6 which constitute the collimator section are arranged in a tilted manner with respect to the optical axis of the telescope section, and the tilt angle is 22.5 degrees to an incident direction of a principal ray to each mirror.

### Convex Mirror M6 for Reducing Size and Correcting Curvature of Field

With such an arrangement, the reflective collimator section may be made compact. Among the four mirrors which constitute the collimator section, M3, M4 and M5 substantially function as concave mirrors and M6 substantially functions as a convex mirror. Here, M3 and M4 each contribute, as a concave mirror, to the reduction in the size of the mirrors M4 and M5 by suppressing diffusion of reflected light flux.

Further, it is intended to reduce the size of the convex mirror M6 (i.e., to reduce the size of a reflection region) by causing the converged light flux to be incident on the convex mirror M6 by the concave mirror M5. In addition to that, the size of the reflective optical system in the optical path direction may be reduced by shortening a focal length of the convex mirror M6 which cancels the Petzval sum of M1 to M5 of which value has become large because all of M1 to M5 are concave mirrors. In a configuration in which diverged light flux, not converged light flux, is incident on the convex mirror, if the focal length of the convex mirror is shortened, the light flux is further diverged and the size of the reflective optical system is increased and reduction in size of the reflective optical system is not achieved.

Therefore, such a configuration achieves compactness and, at the same time, cancels the Petzval sum of the concave mirrors M1 and M2 of the telescope section of the Gregorian telescope and the concave mirrors M3, M4, and M5 of the collimator section, thereby desirably correcting the curvature of field.

Biconic Aspheric Surfaces M3 and M4 which Correct Astigmatism

Each of the four mirrors constituting the collimator section has an aspheric surface which is not rotationally symmetric. Among these, M3 and M4 each is a curved aspheric surface that is symmetrical only about two coordinate axes which cross perpendicularly to each other. In particular, M3 and M4 each is a Biconic aspheric surface having different curvatures and conic coefficients with respect to the two coordinate axes. For M3 and M4 disposed in a tilted manner with respect to the incident light flux, a footprint, i.e., an effective usage region, of the light flux which corresponds to the reflective surface has a substantially elliptical shape. Therefore, if the surface shapes of the mirrors are rotationally symmetrical, the wavefront phase change caused in the incident light flux may become asymmetrical.

Therefore, regarding the surface shape of the mirror, it is more rational that the major axis direction and the minor axis direction are different in length in accordance with the substantially elliptical shape of the incident light flux, and the Biconic shape is employed since generation of aberration in each reflective surface may be suppressed to be small. In particular, the curvature is flatter in the major axis direction and is steeper in the minor axis direction. In this manner, astigmatism may be corrected on M3 and M4 which are the Biconic aspheric surfaces having a less complex (i.e., more simple) shape compared to that of a Zernike aspheric surface described below.

M5 and M6 of Zernike Aspheric Surfaces which Correct Coma Aberration and the Like

M5 and M6 each is an aspheric surface having 5th-, 8th- and 11th-order shape components when an aberration function is developed to a Zernike polynomial. That is, M5 and M6 each is an aspheric surface having shape components of Zernike5 to Zernike36 expressed by the Expression below. Here, the optical axis direction corresponds to a z-axis, a direction vertical to the optical axis corresponds to an h-axis, and a light traveling direction is defined as a positive direction. R is a paraxial radius of curvature, k is a conic coefficient, Zernikej is j-th Zernike polynomial and Cj is a coefficient of Zernikej.

$$\begin{matrix}z = \frac{( 1 / R ) {h}^{2}}{1 + \sqrt{1 - ( 1 + k ) {( h / R )}^{2}}} + {\sum }_{J = 5}^{36} {C}_{j} {Zernike}_{j} \\ Zernike 5 = {a}^{⋀} 2 * cos ( 2 θ ) \\ Zernike 6 = {a}^{⋀} 2 * sin ( 2 θ ) \\ Zernike 7 = ( 3 * {a}^{⋀} 3 - 2 * a ) * cos θ \\ Zernike 8 = ( 3 * {a}^{⋀} 3 - 2 * a ) * sin θ \\ Zernike 9 = 6 * {a}^{⋀} 4 - 6 * {a}^{⋀} 2 + 1 \\ Zernike 10 = {a}^{⋀} 3 * cos ( 3 θ ) \\ Zernike 11 = {a}^{⋀} 3 * sin ( 3 θ ) \\ Zernike 12 = ( 4 * {a}^{⋀} 4 - 3 * {a}^{⋀} 2 ) * cos ( 2 θ ) \\ Zernike 13 = ( 4 * {a}^{⋀} 4 - 3 * {a}^{⋀} 2 ) * sin ( 2 θ ) \\ Zernike 14 = ( 10 * {a}^{⋀} 5 - 12 * {a}^{⋀} 3 + 3 * a ) * cos θ \\ Zernike 15 = ( 10 * {a}^{⋀} 5 - 12 * {a}^{⋀} 3 + 3 * a ) * sin θ \\ Zernike 16 = 20 * {a}^{⋀} 6 - 30 * {a}^{⋀} 4 + 12 * {a}^{⋀} 2 - 1 \\ Zernike 17 = {a}^{⋀} 4 * cos ( 4 θ ) \\ Zernike 18 = {a}^{⋀} 4 * sin ( 4 θ ) \\ Zernike 19 = ( 5 * {a}^{⋀} 5 - 4 * {a}^{⋀} 3 ) * cos ( 3 θ ) \\ Zernike 20 = ( 5 * {a}^{⋀} 5 - 4 * {a}^{⋀} 3 ) * sin ( 3 θ ) \\ Zernike 21 = ( 15 * {a}^{⋀} 6 - 20 * {a}^{⋀} 4 + 6 * {a}^{⋀} 2 ) * cos ( 2 θ ) & \\ Zernike 22 = ( 15 * {a}^{⋀} 6 - 20 * {a}^{⋀} 4 + 6 * {a}^{⋀} 2 ) * sin ( 2 θ ) \\ Zernike 23 = ( 35 * {a}^{⋀} 7 - 60 * {a}^{⋀} 5 + 30 * {a}^{⋀} 3 - 4 * a ) * cos θ \\ Zernike 24 = ( 35 * {a}^{⋀} 7 - 60 * {a}^{⋀} 5 + 30 * {a}^{⋀} 3 - 4 * a ) * sin θ \\ Zernike 25 = 70 * {a}^{⋀} 8 - 140 * {a}^{⋀} 6 + 90 * {a}^{⋀} 4 - 20 * {a}^{⋀} 2 + 1 & \\ Zernike 26 = {a}^{⋀} 5 * cos ( 5 θ ) \\ Zernike 27 = {a}^{⋀} 5 * sin ( 5 θ ) \\ Zernike 28 = ( 6 * {a}^{⋀} 6 - 5 * {a}^{⋀} 4 ) * cos ( 4 θ ) \\ Zernike 29 = ( 6 * {a}^{⋀} 6 - 5 * {a}^{⋀} 4 ) * sin ( 4 θ ) \\ Zernike 30 = ( 21 * {a}^{⋀} 7 - 30 * {a}^{⋀} 5 + 10 * {a}^{⋀} 3 ) * cos ( 3 θ ) \\ Zernike 31 = ( 21 * {a}^{⋀} 7 - 30 * {a}^{⋀} 5 + 10 * {a}^{⋀} 3 ) * sin ( 3 θ ) & \\ Zernike 32 = ( 56 * {a}^{⋀} 8 - 105 * {a}^{⋀} 6 + 60 * {a}^{⋀} 4 - 10 * {a}^{⋀} 2 ) * cos ( 2 θ ) \\ Zernike 33 = ( 56 * {a}^{⋀} 8 - 105 * {a}^{⋀} 6 + 60 * {a}^{⋀} 4 - 10 * {a}^{⋀} 2 ) * sin ( 2 θ ) & \\ Zernike 34 = ( \begin{matrix}126 * {a}^{⋀} 9 - 280 * {a}^{⋀} 7 + 210 * \\ {a}^{⋀} 5 - 60 * {a}^{⋀} 3 + 5 * a\end{matrix} ) * cos θ \\ Zernike 35 = ( \begin{matrix}126 * {a}^{⋀} 9 - 280 * {a}^{⋀} 7 + \\ 210 * {a}^{⋀} 5 - 60 * {a}^{⋀} 3 + 5 * a\end{matrix} ) * sin θ & \\ Zernike 36 = 252 * {a}^{⋀} 10 - 630 {a}^{⋀} 8 + 560 * {a}^{⋀} 6 - 210 * {a}^{⋀} 4 + 30 * {a}^{⋀} 2 - 1 & \end{matrix}$$

In the Expression, a is the distance from the center of the mirror, and θ is an angle of direction in the reflective surface of each mirror of the collimator section. If the optical axis of the telescope section is defined as a Z-axis, a rotation axis about which each mirror of the collimator section is tilted with respect to the Z-axis is defined as an X-axis (which is the direction vertical to the paper sheet of FIG. 2), and a direction which perpendicularly crosses the X-axis on the reflective surface of each mirror (a reflective surface installation direction in FIG. 2) is defined as a Y-axis, θ is set to be the angle of direction based on the X-axis. Regarding the sign of θ, the counterclockwise direction is positive when the light incidence side is seen from the reverse side of the reflective surface.

Generally, a polynomial expressed as the sum of these orthogonal functions is called the Fringe Zernike polynomial and is used to express components of a surface shape error and a wavefront error of an optical element. In the Expression above, Zernike5 and Zernike6 express astigmatism-shaped, Zernike7 and Zernike8 express coma-shaped, Zernike9 expresses spherical aberration-shaped, and Zernike10 and Zernike11 express trefoil-shaped surface shape errors. The Zernike5 component included in the surface shape of M5 and M6 has a function to correct an influence of substantially elliptical incident light flux due to a tilted arrangement like the Biconic shape of M3 or M4.

The Zernike8 component and the Zernike11 component of M5 and M6 have shapes that may correct the coma-shaped and trefoil-shaped asymmetrical wavefront errors that have not been sufficiently corrected by M3 and M4. M5 and M6 also add still higher order shape components, i.e., Zernike12 or higher, and correct high order asymmetrical wavefront aberration.

### Numerical Data

Next, numerical data of the present embodiment will be given in Table 1. In table 1, R represents a paraxial radius of curvature and d represents a surface interval. Regarding the sign of the surface interval in Table 1, when the light incident direction from an object under observation is defined as the positive direction along the Z-axis, the interval toward +Z direction is defined as positive. After the light is reflected once on the mirror, the light proceeds in the −Z direction and thus the sign of the surface interval is also inverted. Regarding the radius of curvature R, when the center of curvature exists on the −Z side, the sign of the radius of curvature R is negative.

α is angular magnification when the telescope section and the collimator section are combined, and FNO is an F-number of the telescope section. The subject distance on the optical design is infinity and an aperture surface is the first surface. Collimated φ60 mm-diameter light flux is emitted from the reflective optical system of the present embodiment. As shown in Table 1, the absolute value of the Petzval sum of the mirrors M1 to M6 of the present embodiment is smaller than the absolute value of the Petzval sum of the telescope section and thus the curvature of field is corrected desirably as the entire reflective optical system.

The reflective optical system 100 of the present embodiment has six aspheric surfaces. Among these, the aspheric surface shapes of M1 and M2 are rotationally symmetrical. When the optical axis direction corresponds to a z-axis, the direction vertical to the optical axis corresponds to an h-axis, the light traveling direction is defined as a positive direction, R is the paraxial radius of curvature, k is the conic coefficient and A to C are 4th- to 8th order aspheric surface coefficients, the following Expression holds.

$$z = \frac{( 1 / R ) {h}^{2}}{1 + \sqrt{1 - ( 1 + k ) {( h / R )}^{2}}} + A {h}^{4} + {Bh}^{6} + {Ch}^{8}$$

When the aspheric surface shapes of M3 and M4 are the Biconic shapes as described above, the radius of curvature in the direction of X-axis is Rx, the conic coefficient in the direction of X-axis is kx, the radius of curvature in the direction of Y-axis is Ry and the conic coefficient in the direction of Y-axis is ky, the height z of the mirror surface is expressed by the following Expression.

$$z = \frac{( {x}^{2} / {R}_{x} ) + ( {y}^{2} / {R}_{y} )}{1 + \sqrt{1 - ( 1 + {k}_{x} ) {( x / {R}_{x} )}^{2} - ( 1 + {k}_{y} ) {( y / {R}_{y} )}^{2}}}$$

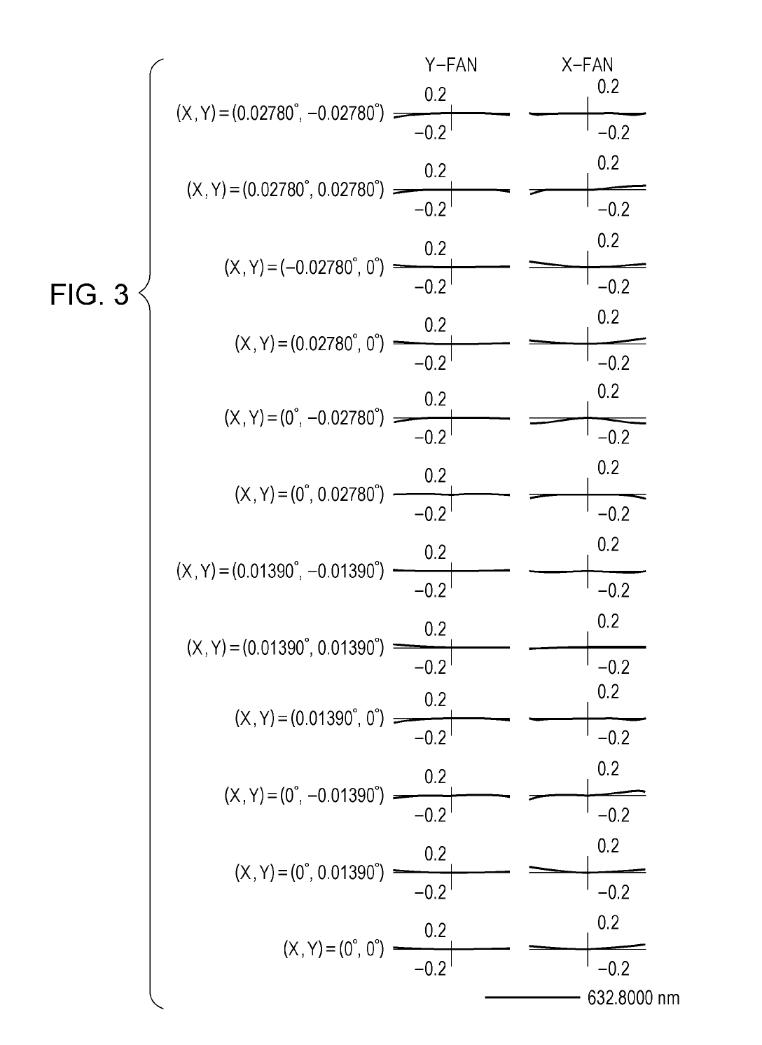

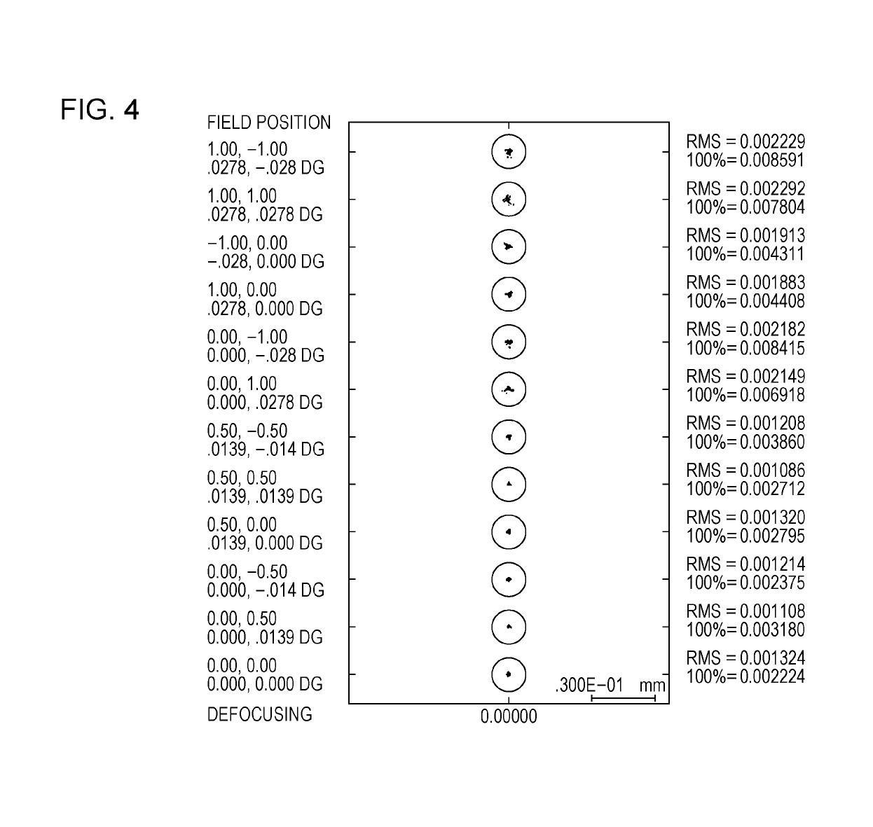

The reflective optical system of the present embodiment has a significantly large effective diameter of the primary mirror M1 of φ1504 mm and the entire optical length of the telescope section of 3100 mm while arranging the collimator section compactly. At the same time, high imaging performance is achieved. FIGS. 3 and 4 are diagrams illustrating the imaging characteristics of the reflective optical system of the present embodiment. Evaluation of the imaging characteristics is conducted by calculating characteristics when imaging is performed with an ideal lens having a focal length of 600 mm placed at the exit pupil position EXP.

In the present embodiment, since the collimator section includes the convex mirror on which the converged light flux is incident, the reflective optical system may be made compact and the Petzval sum of all the mirrors may be desirably corrected, whereby the curvature of field is also corrected to be sufficiently small. Therefore, in the present embodiment, an evaluation imaging surface after imaging on the ideal lens is a plane.

FIG. 3 is a diagram illustrating wavefront aberration in each angle of view, in which the horizontal axis corresponds to a relative coordinate on a pupil plane and the vertical axis corresponds to the wavefront aberration. Y-FAN and X-FAN in FIG. 3 represent Y cross section and X cross section on the pupil plane, respectively. The wavefront aberration is suppressed desirably to equal to or lower than 20 mλRMS at the maximum value of the total angle of view.

FIG. 4 is a spot diagram in each angle of view and illustrates condensing degree of light flux on the evaluation imaging surface. Circles drawn in FIG. 4 represent the size of the airy disc due to diffraction. FIGS. 3 and 4 show that the reflective optical system of the present embodiment implements diffraction limit performance with margin across the total angle of view including the curvature of field. This margin is important to secure sufficient allowable margin budget at the time of manufacture.

TABLE 1
ANGULAR MAGNIFICATION A = −25.0 FNO = 8.5 TOTAL ANGLE
OF VIEW = 0.0556° × 0.0556°
SURFACE NUMBER RADIUS OF CURVATURE R SURFACE
INTERVAL d MATERIAL EFFECTIVE DIAMETER
1 (ENP) ∞ (APERTURE) 3100.0000 --- 1500.0
2 (M1) −4629.3400(ASPHERICAL) −2800.0000 MIRROR 1504.2
3 (M2) 821.0326(ASPHERICAL) 2660.0000 MIRROR 314.2
4 (F1) ∞ (TELESCOPE SECTION FOCUS) 740.1072 --- 22.4
5 (M3) −4979.0268(ASPHERICAL) −155.2914 MIRROR 127.0
6 (M4) 3127.0264(ASPHERICAL) 10.2914 MIRROR 136.6
7 (M5) −560.0186(ASPHERICAL) −155.0000 MIRROR 136.2
8 (M6) −433.5512(ASPHERICAL) 200.0000 MIRROR 72.6
9 (EXP) ∞ (EXIT PUPIL) --- --- 60.0
(ASPHERICAL)
SURFACE k A (4th order) B (6th order) C (8th order)
2 −1.04364 0.00000 0.00000 0.00000
SURFACE k A (4th order) B (6th order) C (8th order)
3 −0.32275 0.00000 0.00000 0.00000
SURFACE Ry Rx ky kx
5 −4979.0268 −9837.3910 +2.00000 −2.00000
SURFACE Ry Rx ky kx
6 3127.0264 3255.5606 +2.00000 −2.00000
SURFACE Norm Radius k
7 74.0000 −29.71824
Zernike5 Zernike6 Zernike7 Zernike8
−8.2263E−1 0.0000E+0 0.0000E+0 +4.3477E−2
Zernike9 Zernike10 Zernike11 Zernike12
−7.7124E−2 0.0000E+0 +1.6198E−2 −1.2702E−3
Zernike13 Zernike14 Zernike15 Zernike16
0.0000E+0 0.0000E+0 +1.7677E−4 +4.5231E−3
Zernike17 Zernike18 Zernike19 Zernike20
+4.4747E−5 0.0000E+0 0.0000E+0 +6.5197E−5
Zernike21 Zernike22 Zernike23 Zernike24
+5.0395E−5 0.0000E+0 0.0000E+0 +1.2979E−5
Zernike25 Zernike26 Zernike27 Zernike28
−3.5253E−4 0.0000E+0 +9.9597E−6 −8.8245E−6
Zernike29 Zernike30 Zernike31 Zernike32
0.0000E+0 0.0000E+0 −1.4190E−6 +1.4760E−5
Zernike33 Zernike34 Zernike35 Zernike36
0.0000E+0 0.0000E+0 −5.2627E−8 +2.6136E−5
SURFACE Norm Radius k
8 45.0000 +50.71566
Zernike5 Zernike6 Zernike7 Zernike8
−5.8613E−1 0.0000E+0 0.0000E+0 +2.9504E−2
Zernike9 Zernike10 Zernike11 Zernike12
+8.4901E−2 0.0000E+0 +1.9379E−2 −2.2827E−3
Zernike13 Zernike14 Zernike15 Zernike16
0.0000E+0 0.0000E+0 +3.3217E−4 +1.0455E−2
Zernike17 Zernike18 Zernike19 Zernike20
+1.6422E−4 0.0000E+0 0.0000E+0 +1.8436E−4
Zernike21 Zernike22 Zernike23 Zernike24
+8.6349E−5 0.0000E+0 0.0000E+0 +3.2054E−5
Zernike25 Zernike26 Zernike27 Zernike28
+1.1294E−3 0.0000E+0 +3.3286E−5 +9.0585E−6
Zernike29 Zernike30 Zernike31 Zernike32
0.0000E+0 0.0000E+0 +5.2225E−6 −1.0014E−5
Zernike33 Zernike34 Zernike35 Zernike36
0.0000E+0 0.0000E+0 +4.2315E−6 +8.9775E−5
(PETZVAL SUM)
SURFACE 1/f
2 0.000432
3 0.002436
5 0.000402
6 0.000640
7 0.003188
8 −0.005411
SUM 0.001686
Second Embodiment

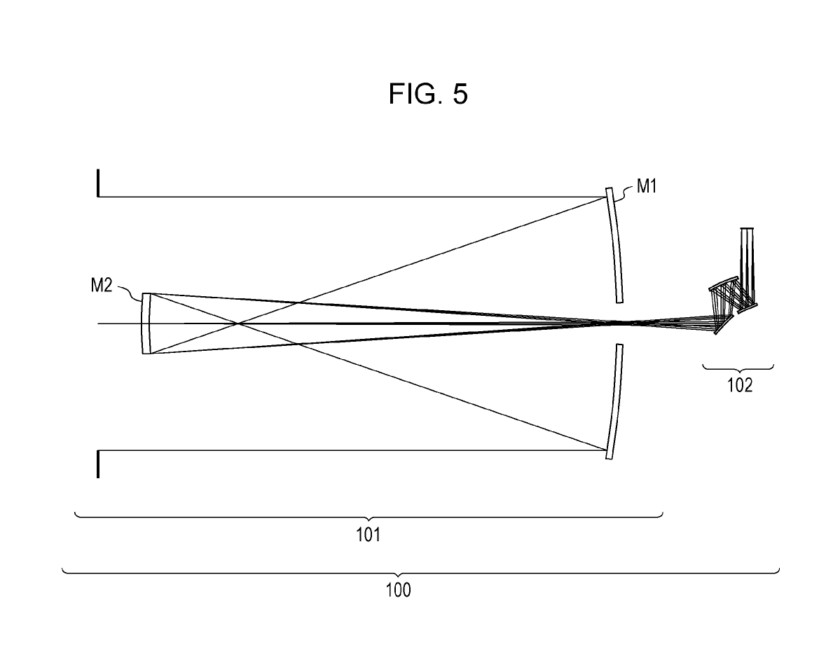

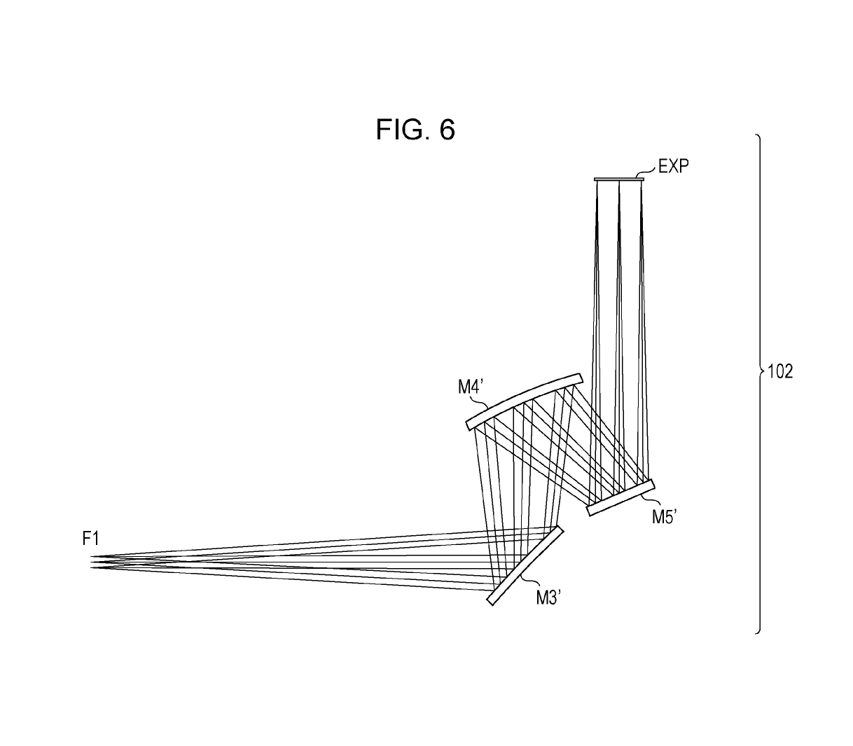

FIG. 5 is a diagram illustrating an optical arrangement of a reflective optical system according to a second embodiment of the present disclosure and FIG. 6 is an enlarged view of a collimator section of the reflective optical system. The second embodiment differs from the first embodiment in the configuration of the collimator section: a first mirror M3′, a second mirror M4′ and a third mirror M5′ as a mirror group constituting the collimator section are arranged along an optical path. Here, M5′ is disposed at the rearmost position along the optical path from a subject image position and reflects converged light flux as collimated light flux. The configuration of a telescope section is the same as that of the first embodiment: light is reflected on the concave primary mirror M1, reflected on the concave secondary mirror M2, and then an image of a subject is formed on the focal plane F1 of the telescope section.

The reflective optical system 100 is mounted on an unillustrated artificial satellite and is placed in an orbit around the earth, an orbit around the astronomical object or the like. Observation light incident from the earth surface or an astronomical object which is a subject is reflected on the concave primary mirror M1 having a hole at the center thereof, reflected on the concave secondary mirror M2, and then forms an image of the subject on the focal plane F1 of the telescope section. The observation light is then reflected on the three mirrors (M3′, M4′ and M5′ in this order along the optical path) arranged in a respectively tilted manner with respect to the optical axis of the telescope section 101 and forms an exit pupil at a position of EXP. Specifically, the tilt angle is 45 degrees regarding M3′ and 22.5 degrees regarding M4′ and M5′ with respect to an incident direction of a principal ray to each mirror.

The collimated light flux emitted from the collimator section 102 is led to an observation device. With such an arrangement, the reflective collimator section may be made compact. Among the three mirrors which constitute the collimator section, M3′ and M5′ function as convex mirrors and M4′ functions as a concave mirror. Here, by causing the converged light flux to be incident on M5′, diversion of light flux is suppressed, whereby the size of the mirror of the convex mirror may be reduced and the focal length of the convex mirror M5′ may be shortened. On the contrary, in a configuration in which the diverged light flux is incident on the convex mirror M5′, if the focal length of the convex mirror M5′ is shortened, the light flux may further be diverged and the size of the optical system may be increased, which situation is undesirable.

In the present embodiment, M3′ is also a convex mirror (however, light flux incident thereon is diverged light flux). The Petzval sum of M1 and M2 of the telescope section of the Gregorian telescope and the concave mirror M4′ of the collimator section is canceled by the convex mirrors M3′ and M5′, thereby desirably correcting the curvature of field.

Here, in the present embodiment, positions and tilt angles of the mirrors M3′, M4′ and M5′ are defined such that the light flux reflected on M5′ does not cross either the light flux incident from an image of the subject F1 and incident on M3′ or the light flux reflected on M3′ and incident on M4′. Such a configuration achieves compactness and, at the same time, desirably corrects several aberrations, such as coma aberration due to tilted arrangement of the mirrors to the incident light flux.

M3′, M4′ and M5′ are aspheric surfaces having shape components of Zernike5 to Zernike36 expressed by Expression 1 above. The Zernike5 component included in the surface shape of M3′, M4′ and M5′ has a function to correct an influence of substantially elliptical incident light flux due to a tilted arrangement. For M3′, M4′ and M5′ disposed in a tilted manner with respect to the incident light flux, a footprint, i.e., an effective usage region, of the light flux which corresponds to the reflective surface has a substantially elliptical shape. Therefore, if the surface shapes of the mirrors are rotationally symmetrical, the wavefront phase change caused in the incident light flux may become asymmetrical.

Therefore, regarding the surface shape of the mirror, it is more rational that the major axis direction and the minor axis direction are different in length in accordance with the substantially elliptical shape of the incident light flux, and generation of aberration in each reflective surface may be suppressed to be small with the Zernike5 component. The Zernike8 component and the Zernike11 component of M3′, M4′ and M5′ have shapes that may correct the asymmetrical wavefront errors, such as coma-shaped and trefoil-shaped asymmetrical wavefront errors. M3′, M4′ and M5′ also add still higher order shape components, i.e., Zernike12 or higher, and correct high order asymmetrical wavefront aberration.

### Numerical Data

Next, numerical data of the second embodiment will be given in Table 2. In table 2, R represents a paraxial radius of curvature and d represents a surface interval. α is angular magnification when the telescope section and the collimator section are combined, and FNO is an F-number of the telescope section. The subject distance on the optical design is infinity and an aperture surface is the first surface. Collimated φ51 mm-diameter light flux is emitted from the reflective optical system of the present embodiment. As shown in Table 2, the absolute value of the Petzval sum of the mirrors M1 to M5′ of the present embodiment is smaller than the absolute value of the Petzval sum of the telescope section and thus the curvature of field is corrected desirably as the entire reflective optical system.

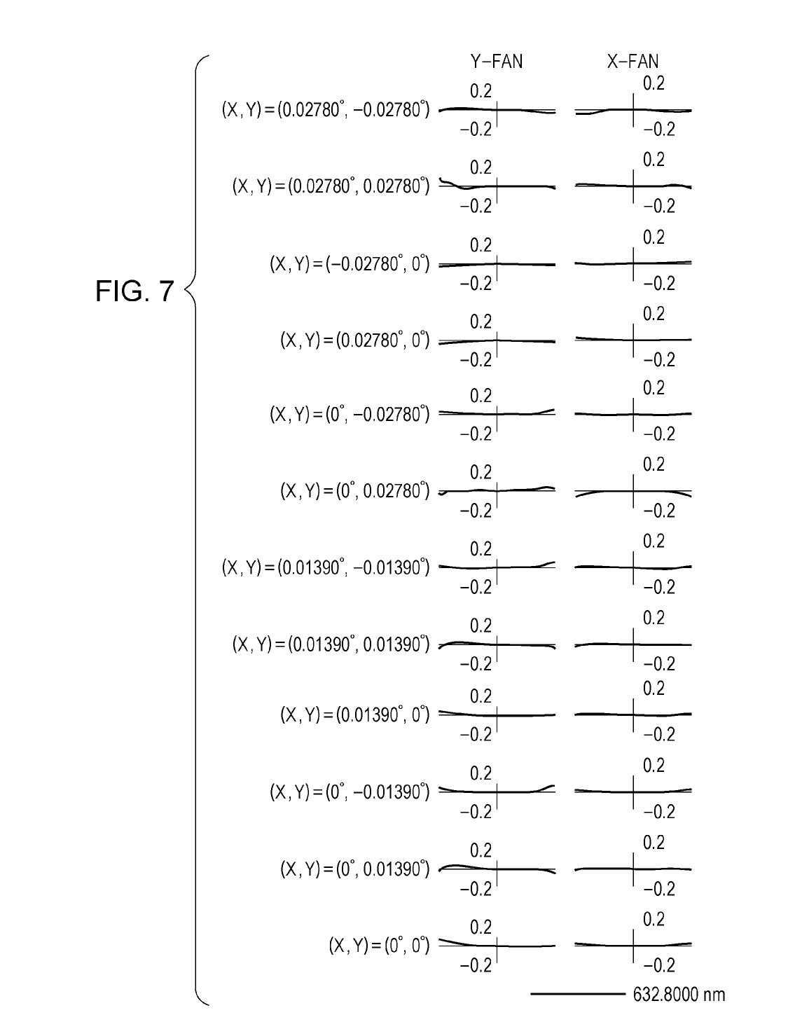

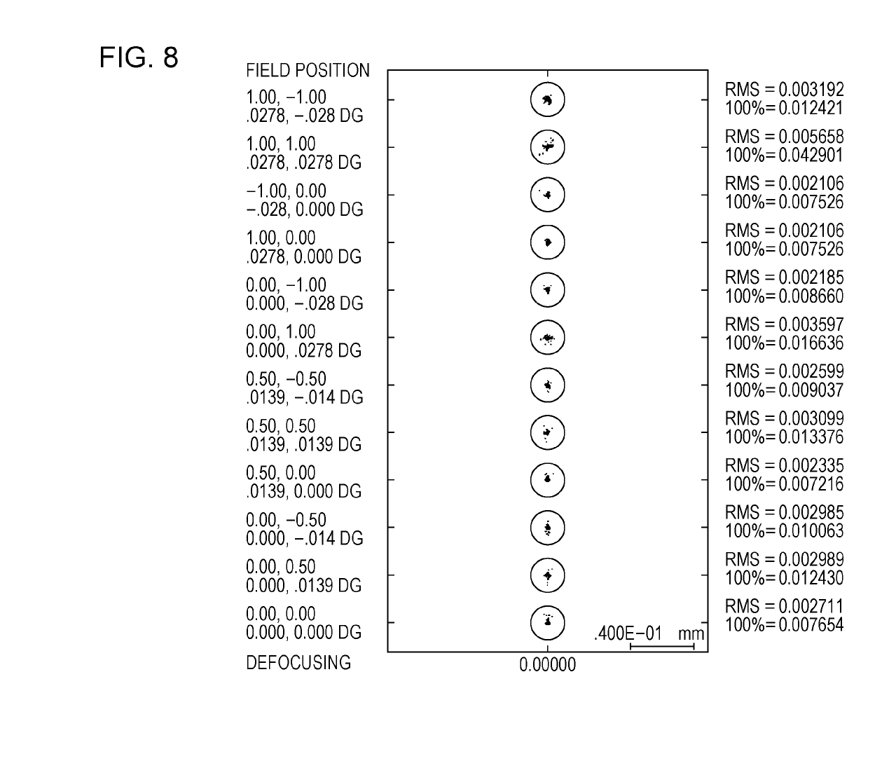

The reflective optical system 100 of the present embodiment has five aspheric surfaces. Among these, the aspheric surface shape of M1 and M2 is rotationally symmetrical and is expressed by Expression 2 above. Further, the reflective optical system of the present embodiment has a significantly large effective diameter of the primary mirror M1 of φ1504 mm and the entire optical length of the telescope section of 3215 mm while arranging the collimator section compactly. At the same time, high imaging performance is achieved. FIGS. 7 and 8 are diagrams illustrating the imaging characteristics of the reflective optical system of the present embodiment. Evaluation of the imaging characteristics is conducted by calculating characteristics when imaging is performed with an ideal lens having a focal length of 600 mm placed at the exit pupil position EXP.

In the present embodiment, since the collimator section includes the convex mirror on which the converged light flux is incident, the reflective optical system may be made compact and, at the same time, the Petzval sum of all the mirrors may be desirably corrected, whereby the curvature of field is also corrected to be sufficiently small. Therefore, in the present embodiment, an evaluation imaging surface after imaging on the ideal lens is a plane.

FIG. 7 is a diagram illustrating wavefront aberration in each angle of view, in which the horizontal axis corresponds to a relative coordinate on a pupil plane and the vertical axis corresponds to the wavefront aberration. Y-FAN and X-FAN in FIG. 7 represent Y cross section and X cross section on the pupil plane, respectively. The wavefront aberration is suppressed desirably to equal to or lower than 25 mλRMS at the maximum value of the total angle of view.

FIG. 8 is a spot diagram in each angle of view and illustrates condensing degree of light flux on the evaluation imaging surface. Circles drawn in FIG. 8 represent the size of the airy disc due to diffraction. FIGS. 7 and 8 show that the reflective optical system of the present embodiment implements diffraction limit performance with margin across the total angle of view including the curvature of field. This margin is important to secure sufficient allowable margin budget at the time of manufacture.

TABLE 2
ANGULAR MAGNIFICATION A = −30.0 FNO = 9.3 TOTAL ANGLE
OF VIEW = 0.0556° × 0.0556°
SURFACE NUMBER RADIUS OF CURVATURE R SURFACE
INTERVAL d MATERIAL EFFECTIVE DIAMETER
1 (ENP) ∞ (APERTURE) 3100.0000 --- 1500.0
2 (M1) −4629.3400(ASPHERICAL) −2800.0000 MIRROR 1504.0
3 (M2) 831.9089(ASPHERICAL) 2915.0000 MIRROR 340.0
4 (F1) ∞ (TELESCOPE SECTION FOCUS) 484.5310 --- 19.4
5 (M3′) 1192.9651(ASPHERICAL) −180.6018 MIRROR 106.2
6 (M4′) 383.8961(ASPHERICAL) 150.0000 MIRROR 134.4
7 (M5′) 385.9047(ASPHERICAL) −350.0000 MIRROR 70.2
8 (EXP) ∞ (EXIT PUPIL) --- --- 51.2
(ASPHERICAL)
SURFACE k A (4th order) B (6th order) C (8th order)
2 −0.93916 0.00000 0.00000 0.00000
SURFACE k A (4th order) B (6th order) C (8th order)
3 −0.70545 0.00000 0.00000 0.00000
SURFACE Norm Radius k
5 70.0000 0.00000
Zernike5 Zernike6 Zernike7 Zernike8
+2.9644E−1 0.0000E+0 0.0000E+0 +5.2264E−2
Zernike9 Zernike10 Zernike11 Zernike12
−7.1542E−2 0.0000E+0 +5.2984E−2 −1.5356E−2
Zernike13 Zernike14 Zernike15 Zernike16
0.0000E+0 0.0000E+0 +6.2995E−2 −3.4761E−2
Zernike17 Zernike18 Zernike19 Zernike20
−3.9447E−3 0.0000E+0 0.0000E+0 +1.5670E−2
Zernike21 Zernike22 Zernike23 Zernike24
−2.7114E−3 0.0000E+0 0.0000E+0 +2.0581E−2
Zernike25 Zernike26 Zernike27 Zernike28
−8.5721E−3 0.0000E+0 +6.2997E−3 −7.7682E−4
Zernike29 Zernike30 Zernike31 Zernike32
0.0000E+0 0.0000E+0 +2.0960E−3 +7.8404E−4
Zernike33 Zernike34 Zernike35 Zernike36
0.0000E+0 0.0000E+0 +2.9796E−3 −1.0603E−3
SURFACE Norm Radius k
6 72.0000 0.00000
Zernike5 Zernike6 Zernike7 Zernike8
+1.9124E−1 0.0000E+0 0.0000E+0 +5.8510E−2
Zernike9 Zernike10 Zernike11 Zernike12
−2.9190E−3 0.0000E+0 +2.2980E−2 −1.4598E−3
Zernike13 Zernike14 Zernike15 Zernike16
0.0000E+0 0.0000E+0 +5.5319E−3 −1.7985E−3
Zernike17 Zernike18 Zernike19 Zernike20
−1.0105E−3 0.0000E+0 0.0000E+0 +1.0770E−3
Zernike21 Zernike22 Zernike23 Zernike24
−3.7761E−4 0.0000E+0 0.0000E+0 +1.8397E−3
Zernike25 Zernike26 Zernike27 Zernike28
−4.3065E−4 0.0000E+0 +1.0126E−3 +1.7810E−4
Zernike29 Zernike30 Zernike31 Zernike32
0.0000E+0 0.0000E+0 −6.9099E−5 +1.2496E−4
Zernike33 Zernike34 Zernike35 Zernike36
0.0000E+0 0.0000E+0 +3.3435E−4 −8.5453E−5
SURFACE Norm Radius k
7 45.0000 0.00000
Zernike5 Zernike6 Zernike7 Zernike8
−2.1305E−2 0.0000E+0 0.0000E+0 +8.0916E−2
Zernike9 Zernike10 Zernike11 Zernike12
−1.1823E−2 0.0000E+0 +1.4811E−2 −1.0815E−3
Zernike13 Zernike14 Zernike15 Zernike16
0.0000E+0 0.0000E+0 +1.1972E−2 −2.9268E−3
Zernike17 Zernike18 Zernike19 Zernike20
−1.8397E−4 0.0000E+0 0.0000E+0 −5.1886E−4
Zernike21 Zernike22 Zernike23 Zernike24
+6.1501E−4 0.0000E+0 0.0000E+0 +4.3254E−3
Zernike25 Zernike26 Zernike27 Zernike28
−7.1016E−4 0.0000E+0 +7.9701E−4 +3.6509E−4
Zernike29 Zernike30 Zernike31 Zernike32
0.0000E+0 0.0000E+0 −3.6849E−4 +2.8757E−4
Zernike33 Zernike34 Zernike35 Zernike36
0.0000E+0 0.0000E+0 +7.1530E−4 −1.1917E−4
(PETZVAL SUM)
SURFACE 1/f
2 0.000432
3 0.002404
5 −0.001800
6 0.005211
7 −0.005274
SUM 0.000973
Third Embodiment

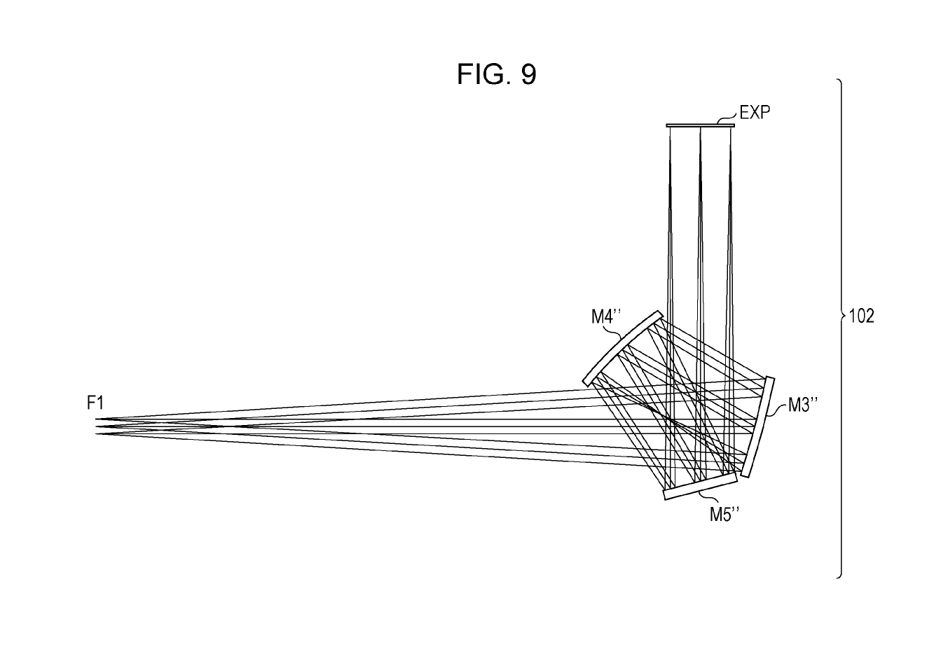

In the second embodiment, it is configured such that the light flux reflected on M5′ does not cross either the light flux incident from an image of the subject F1 and incident on M3 or the light flux reflected on M3′ and incident on M4′. In the present embodiment, as illustrated in FIG. 9, light flux reflected on M5″ crosses light flux incident from an image of subject F1 and incident on M3″ and light flux reflected on M3″ and incident on M4″.

In FIG. 9, M3″ is a concave mirror unlike the second embodiment. However, as long as a convex mirror (M5″ in FIG. 9) on which converged light flux is incident is included in a collimator section, shapes of other mirrors may be changed. Note that at least one of the mirrors in the collimator section needs to be a concave mirror in order to emit diverged light flux from a subject image position (i.e., a focal plane F1 position) as collimated light flux.

### Modification

Preferred embodiments of the present disclosure have been described, but the present disclosure is not limited to the same. Various modifications and changes may be made without departing from the scope of the present disclosure.

First, in each embodiment described above, the shape components to Zernike36 are added to the mirrors. However, it is obvious that lower order shape components, such as Zernike11 or lower, may be used or, alternatively, still higher order shape components, such as Zernike37 or higher, may be added. In each embodiment described above, Zernike term having a shape component asymmetrical about the Y-axis is not added. However, such a term may be added as a degree of freedom and, for example, correct aberration asymmetrical about the Y-axis due to manufacturing error of the telescope section.

### Advantageous Effects

According to the present disclosure, a reflective optical system of the Gregorian telescope, which is capable of maintaining reduction in size of an optical system and correcting curvature of field, and an astronomical observation device using the reflective optical system may be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2013-044289, filed Mar. 6, 2013, which is hereby incorporated by reference herein in its entirety.

What is claimed is:

1. A reflective optical system, comprising:
a telescope section which includes a concave primary mirror and a concave secondary mirror; and
a collimator section which includes at least one concave mirror disposed in a tilted manner with respect to an optical axis of the telescope section and emitting light flux from the telescope section as converged light flux, and at least one convex mirror disposed in a tilted manner with respect to the optical axis of the telescope section and receiving the converged light flux, the collimator section receiving the light flux from the telescope section.

2. The reflective optical system according to claim 1, wherein
the convex mirror is disposed at the rearmost position in the mirror group of the collimator section and reflects the converged light flux as collimated light flux.

3. The reflective optical system according to claim 1, wherein
the collimator section includes a concave mirror as a first mirror, a concave mirror as a second mirror, a concave mirror as a third mirror, and a convex mirror as a fourth mirror on which the converged light flux is incident, the first to fourth mirrors being arranged in this order along an optical path.

4. The reflective optical system according to claim 3, wherein
the light flux in the collimator section crosses between the first mirror and the third mirror and does not cross between the second mirror and the fourth mirror.

5. The reflective optical system according to claim 1, wherein
the collimator section includes a convex mirror as a first mirror, a concave mirror as a second mirror, and a convex mirror as a third mirror on which the converged light flux is incident, the first to third mirrors being arranged in this order along an optical path.

6. The reflective optical system according to claim 5, wherein
the light flux in the collimator section does not cross between the first mirror and the third mirror.

7. The reflective optical system according to claim 5, wherein
the light flux in the collimator section crosses between the first mirror and the third mirror.

8. The reflective optical system according to claim 1, wherein
all the mirrors in the collimator section have aspheric surface shapes.

9. The reflective optical system according to claim 1, wherein
the absolute value of the Petzval sum about the mirrors of the telescope section and the collimator section is smaller than the absolute value of the Petzval sum about the mirrors of the telescope section.

10. The reflective optical system according to claim 9, wherein
the mirrors in the collimator section include
mirrors which include aspheric surfaces having 5th, 8th and 11th order shape components when an aberration function is developed to a Zernike polynomial, and
mirrors which include curved surface shapes symmetrical only about two coordinate axes which cross perpendicularly to each other.

11. The reflective optical system according to claim 10:
wherein the mirrors in the collimator section include
a concave mirror as a first mirror, a concave mirror as a second mirror, a concave mirror as a third mirror, and a convex mirror as a fourth mirror on which the converged light flux is incident, the first to fourth mirrors being arranged in this order along an optical path; and
wherein the first mirror and the second mirror are mirrors each including a curved surface shape symmetrical only about two coordinate axes which cross perpendicularly to each other, and
the third mirror and the fourth mirror are mirrors each including an aspheric surface having 5th, 8th and 11th order shape components when an aberration function is developed to a Zernike polynomial.

12. The reflective optical system according to claim 9:
wherein the mirror in the collimator section includes
a convex mirror as a first mirror, a concave mirror as a second mirror, and a convex mirror as a third mirror on which the converged light flux is incident, the first to third mirrors being arranged in this order along an optical path; and
wherein each mirror includes an aspheric surface that has a 5th, 8th and 11th order shape components when an aberration function is developed to a Zernike polynomial.

13. The reflective optical system according to claim 1, wherein
the at least one concave mirror includes a Biconic surface.

14. The reflective optical system according to claim 1, wherein
the at least one concave mirror includes a Biconic aspheric surface.

15. The reflective optical system according to claim 1, wherein
the at least one concave mirror is symmetrical only about two axes which cross perpendicularly to each other.

16. An astronomical observation device, comprising:
a reflective optical system; and
an exterior which covers the reflective optical system,
wherein
the reflective optical system includes
a telescope section which includes a concave primary mirror and a concave secondary mirror; and
a collimator section which includes at least one concave mirror disposed in a tilted manner with respect to an optical axis of the telescope section and emitting light flux from the telescope section as converged light flux, and at least one convex mirror disposed in a tilted manner with respect to the optical axis of the telescope section and receiving the converged light flux, the collimator section receiving the light flux from the telescope section.
